(19) United States
(12) Patent Application Publication
(10) Pub. No.: US 2006/0260327 A1
(43) Pub. Date: Nov. 23, 2006

(54) APPARATUS AND METHOD FOR RAPIDLY FREEZING SMALL OBJECTS

(76) Inventors: Shoji Kanamori, Vancouver (CA); Tomasz Wysokinski, Richmond (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 10/908,590

(22) Filed: May 18, 2005

(51) Int. Cl. F25B 9/00; F17C 3/10; F25J 1/00

(52) U.S. Cl. 62/6; 62/606; 62/48.2

(57) ABSTRACT

A desktop gas liquefaction system having a gas generator, a cooling unit having a stirling, pulse-tube or stirling-pulse-tube cooler, and an insulated container to receive the liquefied gas. Alternate embodiments may be used to produce 1-20 liters of liquid nitrogen, oxygen, argon, natural gas, or air per day. This compact liquefier allows for on-demand and on-site cryogen generation.

### FIELD OF THE INVENTION

This invention relates generally to the field of gas liquefaction systems.

### BACKGROUND OF THE INVENTION

Cryogenics (technology that uses very low temperatures) is already popular in applications such as high-end medical equipment, scientific research, food processing and semiconductor industries. Our research indicates enormous potential for a broader application of this technology in various new marketplaces and industries. Liquid gas, such as liquid nitrogen, has application in all of the above.

One limitation in adapting cryogenic technology concerns the current supply system of liquid nitrogen. It is generally available from Industrial Gas Suppliers, only for customers who purchase large amounts and live in urban areas. Generally, the supply of liquid nitrogen suffers from a host of drawbacks. Liquid nitrogen is produced at an industrial site and can be delivered to a purchaser, generally within two days on placing an order (provided a sufficiently large quantity is ordered, e.g. 100 litres). Once the liquid nitrogen has been delivered, it must be stored. The longer it is stored, (and the further the delivery site is from the industrial site) the more LN2 is lost through boil off. Storage of large amounts of LN2 presents a hazard and may require transfer to smaller containers for handling.

All of the above points to the need for a means of liquid gas supply that is readily available on site, and doesn't suffer from the drawbacks associated with transfer and storage of large quantities of liquid gas.

Thus there is a potential new market in delivering On Site Liquefaction Systems, which allow anyone to access Liquid nitrogen easily, anywhere, at reasonable cost. Effective use of the technologies available allows us to develop unique liquefaction systems. Combining technology with marketing, we promote our cryogenic solution to international markets.

Liquid nitrogen has application in many areas including: medical and veterinary treatment; research and laboratory applications; education; machinery shops; and, obviously, refrigeration.

### SUMMARY OF THE INVENTION

A small-scale gas liquefaction system is provided that can be used in, for example, medical office, restaurant and bar, and machine shop settings. The liquefaction system requires little or no special set up and can be simply plugged into a standard (single-phase 115 VAC) wall outlet. Depending on the specific embodiment, it will produce 1-20 liters of liquefied gas per day. It provides an economical option for users of relatively small quantities of, for example, liquid nitrogen to obtain liquefied gas.

The gas liquefaction system will liquefy 1-20 liters per day of air, nitrogen, oxygen, argon or natural gas.

The invention comprises a gas generator, a cooling unit having a stirling, pulse-tube or stirling-pulse-tube cooler, and an insulated container below said cooling unit to receive the liquefied gas. The aforesaid components are sized and configured to allow the liquefaction system to be located on a counter top. Although in the preferred embodiment the invention is used to produce liquid nitrogen from air, alternate embodiments may be used to produce liquid oxygen, natural gas, argon or air.

The gas generator and cooling unit together occupy an envelope no larger than 675 mm width, 400 mm depth and 778.1 mm height. The cooling unit itself has maximum dimensions of approximately 152 mm width, 290 mm depth and 369 mm height.

The liquefied gas falls from the cooling unit directly into an insulated container or dewar, which is connected to the cooling unit with a gas-tight seal. The insulated container can be quickly and easily disengaged from the cooling unit, thereby eliminating the need to transfer the liquefied gas to portable containers. The risks associated with handling the liquefied gases are thereby minimized.

### BRIEF DESCRIPTION OF THE DRAWINGS

The invention itself both as to organization and method of operation, as well as additional objects and advantages thereof, will become readily apparent from the following detailed description when read in connection with the accompanying drawings, wherein:

FIG. 1 shows a demonstration unit of the invention;

FIG. 2 is a diagram showing a prototype of a preferred embodiment of the invention;

FIG. 3 is a close-up and detailed view of the cooling unit and insulated container;

FIG. 4 is a cut-away view of the cooling unit and insulated container;

FIG. 5 is a diagram of an alternative embodiment of the invention;

FIG. 6 is an elevation view of the left side of FIG. 5;

FIG. 7 is a partial view of the cooling unit and the top of the insulated container unit showing the internal parts thereof;

FIG. 8 is elevation view of the embodiment of FIG. 5 in which the insulated container stand has been lowered remove the insulated container from its connection to the cooling unit;

FIG. 9 is an elevation view of the embodiment of FIG. 5 in which a liquid withdrawal snout for withdrawing liquid gas is installed in the insulated container; and

FIG. 10 is a perspective view of the embodiment of FIG. 9 showing the liquid withdrawal snout; and

FIG. 11 is a diagram of the preferred embodiment and some of its major applications.

### DETAILED DESCRIPTION WITH REFERENCE TO THE DRAWINGS

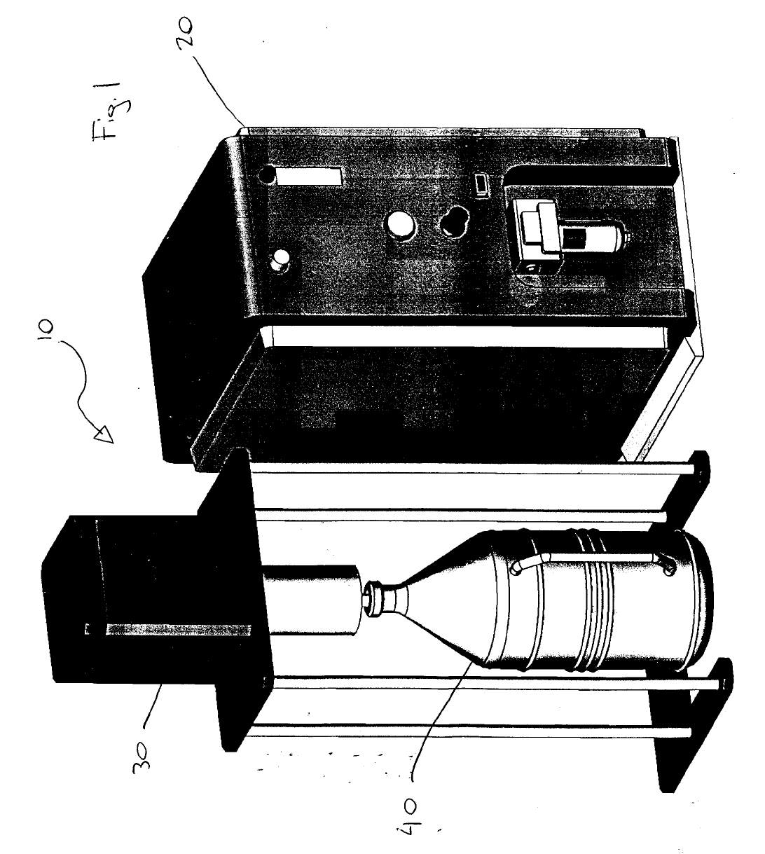

Referring to FIG. 1, a first embodiment of a gas liquefier 10 according to the present invention is shown. The gas liquefier 10 has a gas generator 20, a cooling unit 30 having a stirling, pulse-tube or stirling-pulse-tube cooler, and an insulated container 40.

In the preferred embodiment the gas generator 20 is a nitrogen gas generator that separates nitrogen gas from the air. Suitable gas generators are available from Compressed Gas Technologies Inc. (Windsor, ON, Canada) and System Instruments Co., Ltd. (Tokyo, Japan). In the various alternate embodiments the gas generator will generally have to filter the air to remove dust, etc., and include means for removing water vapour from the gas before it is cooled. In alternate embodiments the gas generator 20 may provide oxygen gas, natural gas, or air to the cooling unit 30 for liquefaction. Commercially available gas generators currently come with physical dimensions as small as 27.5 cm wide, 40 cm deep and 55 cm high.

In the cooling unit 30 the gas from the gas generator 20 is cooled by a stirling, pulse-tube or stirling-pulse-tube cooler to a temperature below the liquefication temperature for that gas. Suitable coolers are available from Sunpower, Inc. (Ohio) and Smach Co., Ltd. (Osaka, Japan). These coolers were originally developed to provide cooling for high end electronic devices for communication, infrared detection and CCD devices. The liquified gas falls from the cooling unit into an insulated container 40 (e.g. a dewar). It is not necessary that the gas be pressurized (relative to the ambient pressure). However, to avoid contamination by reverse flow of air, the pressure inside the insulated container 40 is maintained slightly higher than atmospheric pressure.

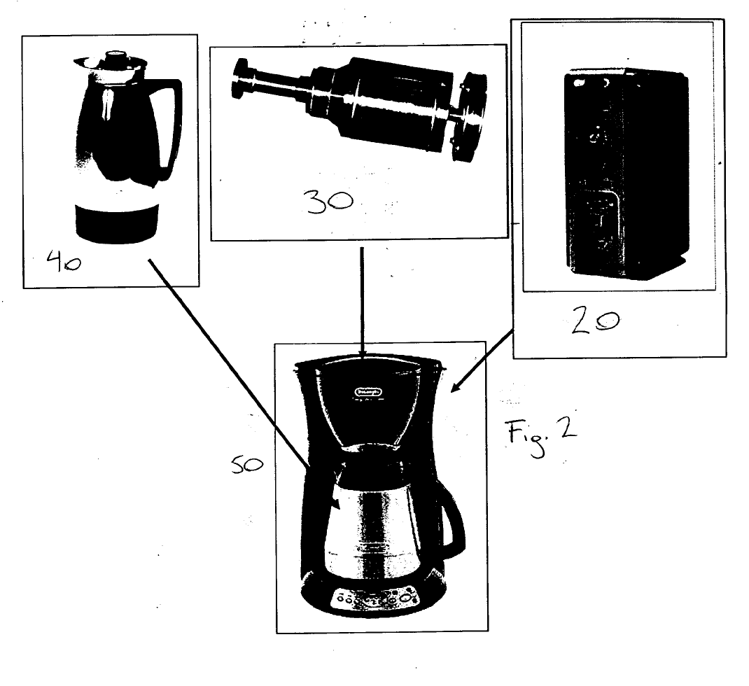

Referring to FIG. 2, a second, prototypical, embodiment of the gas liquefier 50 is shown. The second embodiment is approximately the same size as a coffee machine and in fact, visually, bears some resemblance to a coffee machine. As with the first embodiment of the gas liquifier 10, the second embodiment 50 is made up of a gas generator 20, a cooling unit 30 and an insulated container 40.

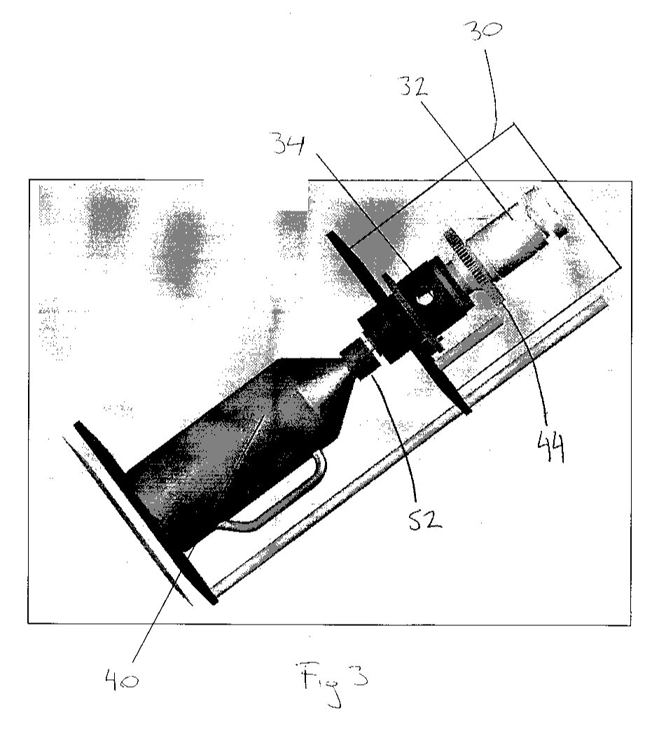

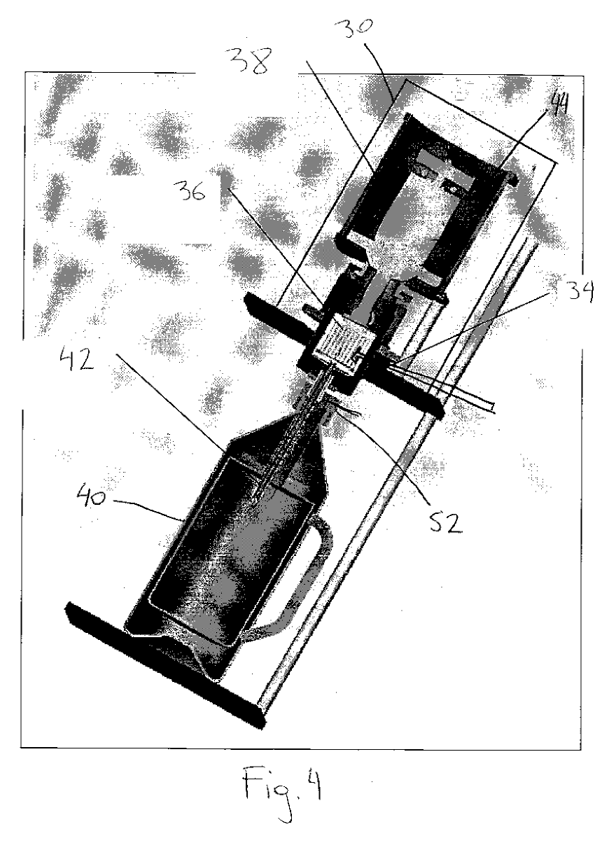

FIGS. 3 and 4 show side and cut-away views of the cooling unit 30 and insulated container 40. The cooling unit 30 is made up of a stirling, pulse-tube or stirling-pulse-tube cooler 32 housed in an air cooling shroud 38. Fan 44 forces air through the cooling shroud 38 to dissipate heat generated at the hot end of the stirling, pulse-tube or stirling-pulse-tube cooler 32. The cold end of the stirling, pulse-tube or stirling-pulse-tube cooler 32 is connected to a condenser 36 which is housed in a vacuum enclosure 34. Liquefied gas flows down the drain 42 from the condenser 36 into the insulated container 40.

Gas may be fed to the cooling unit 30 and insulated container 40 from the gas generator 20 in a number of ways. In the embodiment of FIGS. 1, 3 and 4, gas from the gas generator 20 enters the top of the insulated container 40 at a connection point in the neck 52. From the insulated container 40 the gas flows up the drain 42 to the condenser 36 and then drops back down the drain 42 to the insulated container as a liquid. In this sense the drain 42 is a two-way conduit. This embodiment obviously requires a gas tight connection between the insulated container 40 and the cooling unit 30.

Referring to both FIGS. 1 and 2, in the preferred embodiments 10 and 50, respectively, the invention is powered by electricity and can be simply plugged into a conventional electrical outlet. In a preferred embodiment the invention 10 and 50 is a compact, all-in-one unit that is small enough to sit conveniently on a desk. The Gas generator is small enough to fit within an envelope of 30 cm width by 45 m in depth by 60 cm in height while the cooling unit and insulating container fit within an envelope that is 30% higher and 20% smaller in depth that the gas generator envelope.

Referring to FIGS. 1, 2, 3 and 4, the vacuum enclosure 34 insulates and isolates the cold end of the stirling, pulse-tube or stirling-pulse-tube cooler 32 and the condenser 36 from the atmosphere. There are two ways to drain liquefied gas from the insulated container 40. In either case, the gas liquefaction system 10 and 50 is isolated from the atmosphere except for the connection to the gas supply or gas generator 20.

In the preferred embodiments, the insulated container 40 may be detached from the system 10 and 50 to drain the liquefied gas. Alternatively, the insulated container 40 could be essentially a holding tank, from which liquefied gas could be drained via a drain port (e.g. like a water tap on a sink).

The insulated container 40 could have a gas tight sealing mechanism such that when it is disconnected from the cooling unit 30, the liquefied contents are completely isolated from the environment. In such embodiments, the insulated container 40 would also likely have a pressure release mechanism. The insulated container 40 could also be open to the air once disconnected from the cooling unit 30.

In the preferred embodiment the gas liquefaction system 10 and 50 includes means for monitoring the liquid level in the insulated container 40 such that, when the liquid reaches a certain level, the cooling unit 30 and gas supply 20 are turned off or disconnected from the insulated container 40.

Nitrogen gas generators separate nitrogen gas from air by filtration. Thus the exhaust is enriched with oxygen gas. Therefore, in embodiments of the present gas liquefaction system that are used to produce liquid nitrogen from air, it is desirable to keep the flames and heat sources away from the system.

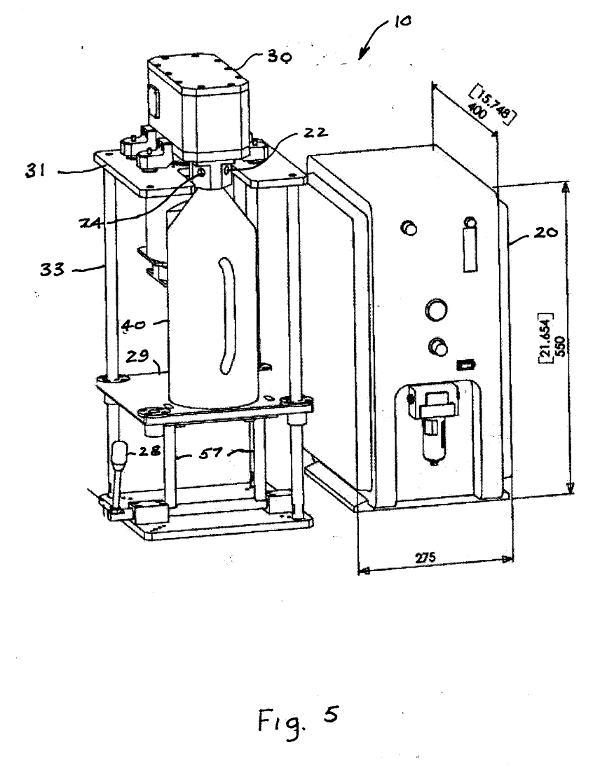

Referring to FIG. 5, an alternative arrangement of the gas liquefier 10 has the insulated container 40 supported by a platform 29 whose elevation is established by a pair of pivotal arms 57 controlled by a lever 28. The platform 29 slides over four guides 33 on each of the four corners that also support a second platform 31 on which is mounted the cooling unit 30. Two inlets 22 and 24 can be used to obtain access to the gas/liquid storage space 55. The dimensions of the condenser and cooler and the stand supporting the insulated container are 300 mm width, 300 mm depth and 778.1 mm height. The dimensions of just the condenser and cooler are 152 mm width, 290 mm depth, and 369 mm height. The gas generator currently being used has an envelope of 275 mm width, 400 mm depth and 550 mm height. Allowing for approximately 100 mm of separation between the gas generator and the liquefaction unit, the overall width of the gas generator, the separation and the width of the stand for the cooling unit and condenser is 675 mm.

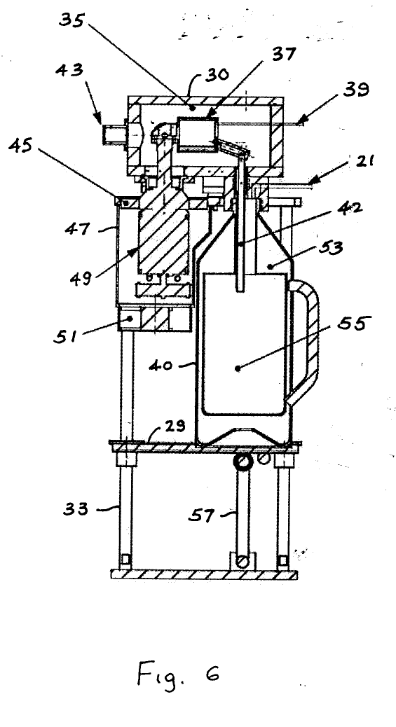

Referring to FIG. 6, the gas supply line can coupled either to inlet 21 leading to an interior of the insulated container 40 or directly to the condenser 37. An evacuation outlet 43 permits preliminary evacuation of chamber 35 by means of a vacuum pump. An air shroud 47 surrounds and insulates the cooler 49. A fan 51 cools the hot end of the Cooler. Cooling fins 46 also provide for heat dissipation from the hot end of the Cooler 49.

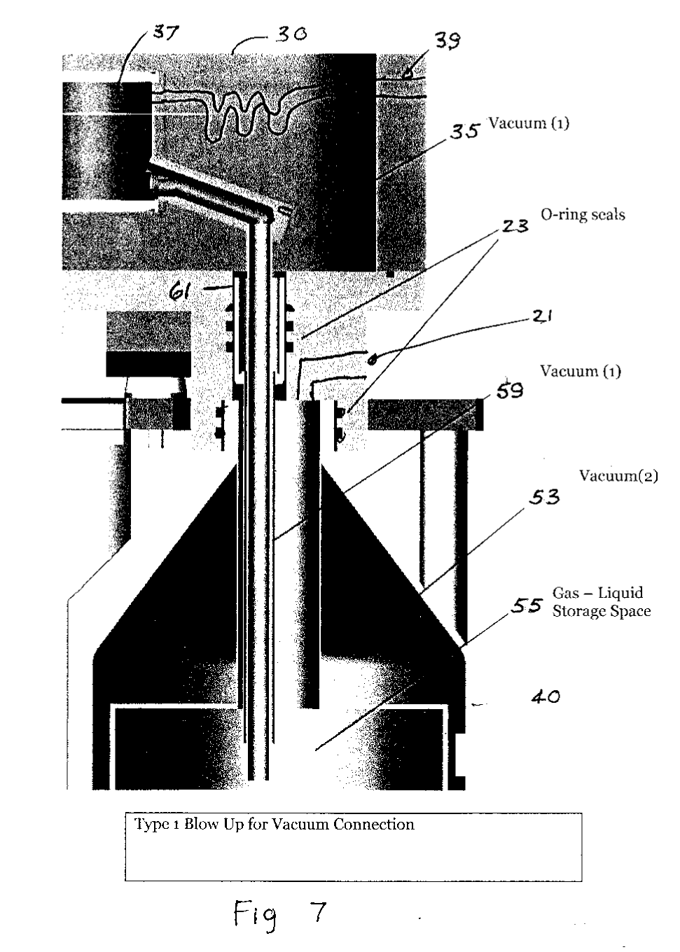

Referring to FIG. 7, the top of the insulated container couples to a bottom of the condenser by means of 0-rings 23, which seal around the top of insulated container 40. Here the gas supply line can couple either to inlet 39 leading to the condenser 37 or to inlet 21 leading to the interior of the insulated container 40. The upper set of O-rings 23 seal the elongated tube 61 from the interior 55 of the cooling unit 30.

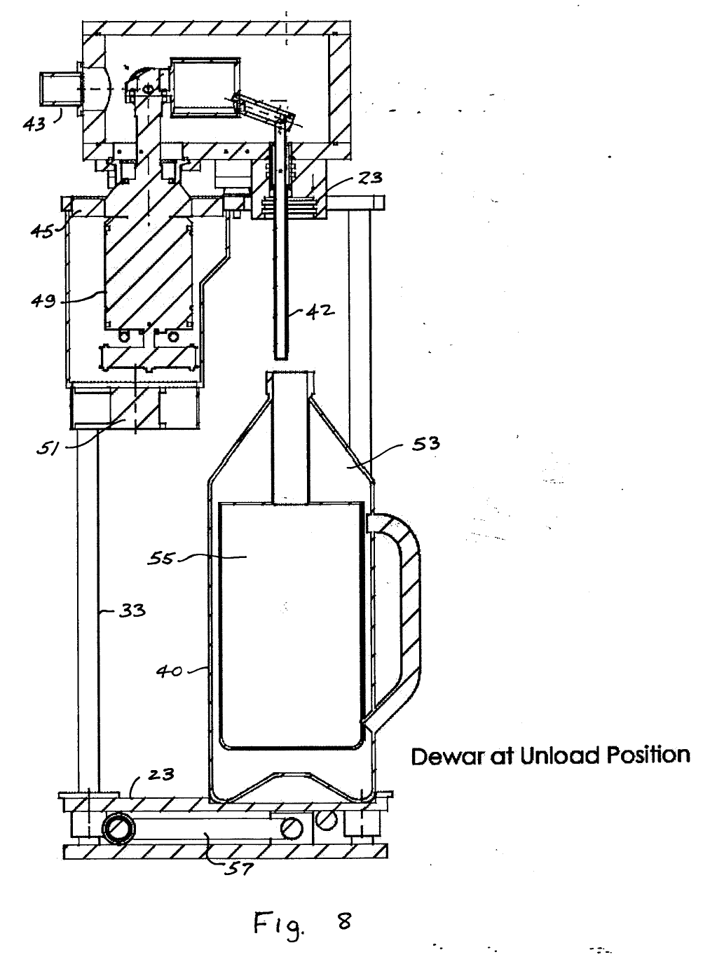

Referring to FIG. 8, the insulated container 40 has been lowered by pivoting arms 57 to a horizontal position so that the container has been pulled away from the drain 42 allowing it to be moved in order to access its liquid contents.

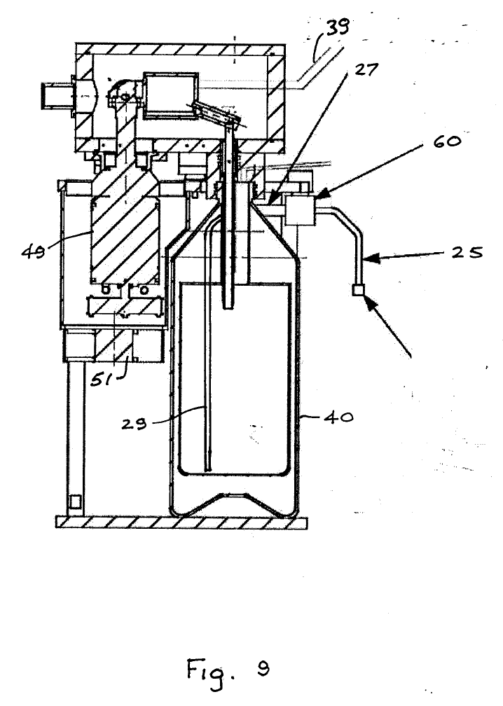

FIG. 9 is identical to the embodiment of FIG. 6 except that the insulated container 40 has a foam insulated line 25, a valve or solenoid 60 and a vacuum jacket line 27 installed in order to extract liquid gas without moving the insulated container 40.

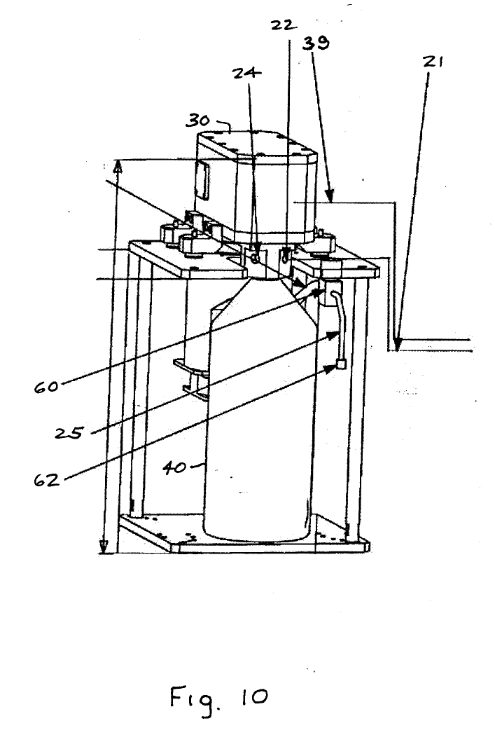

FIG. 10 shows a different view of the line 25 as well as the gas generator 20.

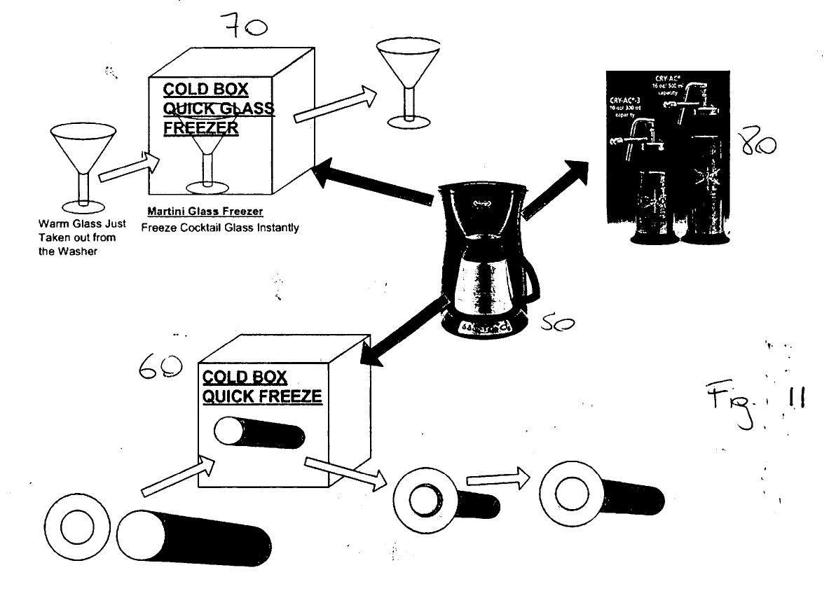

Referring to FIG. 11, three applications of the gas liquefaction system 50 are shown. The gas liquefaction system 50 can be used in a medical setting 80 where, for example, small amount of liquid nitrogen is often used to treat a number of medical conditions (also known as cryotherapy). This type of treatment is used for conditions, such as:

tumors or cancer, especially those of the skin, cervix, eye, brain, prostate and liver cancer;

certain early changes in the skin that might signal possible cancer;

actinic keratosis, a skin condition caused by sun exposure, can be treated with cryotherapy;

cervical dysplasia, or abnormal precancerous cells in a woman's cervix that can lead to cancer of the cervix;

warts, including genital warts from human papilloma virus;

other common skin lesions, such as skin tags, hemangiomas, or seborrheic keratoses;

bleeding during standard surgery;

The gas liquefaction system 50 can also be used to quickly freeze, for example, cocktail and beer glasses. It can also be used in mechanical settings or machine shops, 60 where metal parts can be quickly cooled in order make them fit together.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

What is claimed is:

1. A gas liquefaction system comprising:
a) a gas generator;
b) a cooling unit connected to said gas generator, said cooling unit having a stirling, pulse-tube or stirling-pulse-tube cooler for cooling gas received from said gas generator;
c) an insulated container connected to and positioned below said cooling unit, operative to receive liquefied gas liquefied by said cooling unit;
wherein said gas generator, cooling unit and insulated container are selected and configured to be locatable on a countertop or desktop.

2. The gas liquefaction system of claim 1, wherein said gas generator and said cooling unit fit within an envelope of 675 mm width by 400 mm depth by 778.1 mm height.

3. The gas liquefaction system of claim 1, wherein said cooling unit fits within an envelope of 152 mm width by 290 mm depth and 369 mm height.

4. The gas liquefaction system of claim 1, wherein said gas is one of oxygen, nitrogen, argon, air and natural gas.

5. The gas liquefaction system of claim 1, wherein said insulated container is connected to said gas generator, such that said gas from said gas generator passes through said insulated container and into said cooling unit, where said gas is cooled to a liquid state.

6. The gas liquefaction system of claim 1, wherein said cooling unit is connected to said gas generator and gas from said gas generator passes through a condenser in said cooling unit where it is liquefied and then flows down into said insulated container.

7. The gas liquefaction system of either of claim 1, wherein said insulated container can be disconnected and reconnected to said cooling unit by simply lowering and raising, respectively, said insulated container relative to said cooling unit.

8. The gas liquefaction system of either claim 1, wherein said insulated container is a handheld container.

9. The gas liquefaction system of claim 1, wherein said gas generator is a nitrogen generator operative to produce nitrogen gas from air.

10. The gas liquefaction system of claim 5, including a drain tube extending from an outlet of said condenser into an interior of said insulated container.

11. The gas liquefaction system of claim 1, a neck of said insulated container is sealed to said cooling unit by O-rings.

12. The gas liquefaction system of claim 8, wherein said drain tube has a vacuum jacket enclosing it.

13. The gas liquefaction system of claim 5, wherein said insulated container is supported by a vertically slidable platform which rests on a pair of pivotal arms, said arms pivotal from a vertical orientation to a substantially horizontal orientation.

14. The gas liquefaction system of claim 1, including an insulated line one said insulated container having a tube that extends down into a lower interior of said insulated container and having an exterior portion that includes a valve and a withdrawal snout.
